(19) United States
(12) Patent Application Publication
(10) Pub. No.: US 2016/0215844 A1
(43) Pub. Date: Jul. 28, 2016

(54) Elasticity-Adjustable Corrugated Cavity Fluid Pressure Spring Structure

(71) Applicant: GUANGDONG ZHENGMEI FURNITURE TECHNOLOGY CO.,LTD, Dongguan, Guangdong (CN)

(72) Inventors: Qianan Li, Dongguan (CN); Xiangqian Li, Dongguan (CN)

(21) Appl. No.: 14/443,338

(22) PCT Filed: Apr. 7, 2013
(86) PCT No.: PCT/CN2013/073805

§ 371 Date: May 15, 2015

(30) Foreign Application Priority Data
Nov. 16, 2012 (CN) 201210462299.3

(51) Int. Cl. F16F 9/04

(52) U.S. Cl. CPC F16F 9/0481

(57) ABSTRACT

A compression spring with a sealed chamber formed by a resilient tube body, a top panel unit and a bottom panel unit. The chamber connects to an external elastic structure through a channel and a valve unit. The resilient tube body is a corrugated body defining a crest portion, a trough portion and the remaining portion. A rigid frame structure can be mounted on the crest and trough portions for facilitating expansion in the thinner remaining portion. When the chamber is fluid filled and pressed axially, the remaining portion deforms to hold a larger amount of fluid or the excessive fluid flows through the channel to the elastic structure. A rope unit can be provided for restricting axial expansion and preset a particular length range for a particular use. The valve unit can be controlled before or during the use of the compression spring to control the axial elasticity.

### BACKGROUND OF THE PRESENT INVENTION

1. Field of Invention

The present invention relates to a compression spring unit, and more particularly to a compression spring with a corrugated fluid chamber capable of elasticity adjustment.

2. Description of Related Arts

Compression spring and its principles of use are widely utilized. The question of how to make changes to its structure in view of its work principles to fit different application conditions, and how to improve the compression and expansion action of the compression spring or the deformation for an improvement of elasticity effect are the current new focus of the exiting compression spring. In order to provide the spring for different field of applications, a large number of model and make of compression spring with different design is found in the existing market. The elasticity of the spring is realized by the compression or expansion of the spring itself that a pressure cause the spring to deform and provide elasticity for the realization of the elasticity of the spring. In general, compression spring is used as an accessory or a complementary parts. In view of its function, excessive difficulties in manufacture or excessive cost or resources are not desired. The spring with simple structure and manufacture process are the prerequisite requirements. Also, it is necessary that the spring with improved function and quality for effective access of the markets in order to promote the spring successfully in the market.

### SUMMARY OF THE PRESENT INVENTION

An objective of the present invention is to solve the problem of the existing technological problems and to provide a compression spring with a corrugated fluid chamber capable of elasticity adjustment, through controlling the action of a valve unit to control the fluid flow in or out of the fluid chamber before or during the use of the compression spring, to adjust the internal pressure of the fluid inside the chamber, thereby the control of elasticity along the axial direction and deformation is realized.

Accordingly, in one aspect of the present invention, the present invention provides:

a compression spring with a corrugated fluid chamber capable of elasticity adjustment with a main structure comprising a resilient tube body, a top and a bottom panel units enclosing the resilient tube body to form a sealed chamber, the chamber connected to one or more elastic structures outside the chamber through a channel, a valve unit is provided inside the channel and is capable of holding an excessive fluid, wherein the channel and the chamber are thoroughly connected, wherein the resilient tube body is a corrugated body defining a crest portion, a trough portion and a remaining portion excluding the crest portion and the trough portion, and a rigid frame structure can be mounted on the crest portion and the trough portion such that a wall thickness of the remaining portion is smaller for facilitating an expansion action, wherein when the chamber is filled with a fluid and is pressed along an axial direction of the chamber to change an internal pressure of the fluid inside the chamber, the remaining portion of the resilient tube body is deformed and a volume of the remaining portion is increased to hold a larger amount of fluid or the excessive fluid is forced to flow through the channel to the elastic structure outside the chamber, thereby causing a deformation of the chamber along the axial direction; wherein a rope unit can be provided inside the chamber through connecting the top and the bottom panel units by two ends of the rope unit, when the chamber is filled with the fluid, the rope limits the compression spring from expanding along the axial direction to define a particular length range for use to serve as a particular use, the valve unit is controlled before or during the use of the compression spring to allow the fluid to enter into the chamber from outside or to exit the chamber so as to adjust the internal pressure of the fluid inside the chamber, thereby the control of elasticity along the axial direction is realized.

In particular, the wall thickness of the resilient tube body has a stepped structure in which the wall thickness of the crest portion is greater than the wall thickness of the trough portion at which the crest portion is adjacent to, or the wall thickness of the crest portion is smaller than the wall thickness of the trough portion at which the crest portion is adjacent to.

In particular, the valve unit inside the channel has a valve opening and the fluid control is controlled by a degree of opening of the valve opening, thereby a damping control of the deformation of the compression spring during operation is achieved.

In particular, the rigid frame structure is mounted on the crest portion or the trough portion of the resilient tube body and has a ring or helical structure, or a wall thickness or the crest portion and the trough portion of the resilient tube body is increased such that any desirable deformation through compressing the chamber or filling the fluid into the chamber during operation is avoided instead of providing the rigid frame structure to the crest portion or the trough portion of the resilient tube body.

In particular, the crest portion and the trough portion of the resilient tube body is provided with the rigid frame structure, an increased wall thickness, or a combination of the rigid frame structure and increased wall thickness.

In particular, the two ends of the chamber is provided with an increased wall thickness or with a reinforcement unit of a particular shape for preventing deformation at the two ends.

In particular, the chamber is provided with a decreased wall thickness such that an increased volume is caused through deformation by the internal pressure, or the chamber is provided with the elastic structure outside the chamber in which the elastic structure is capable of expanding under a particular internal pressure, or the chamber is provided with a decreased wall thickness such that an increased volume is caused through deformation by the internal pressure as well as the elastic structure outside the chamber in which the elastic structure is capable of expanding under a particular internal pressure.

In particular, the corrugated body of the resilient tube body is made in elastic materials, the elastic materials includes rubber, soft plastic, or any synthetic materials.

In particular, the rope unit is provided inside the chamber through connecting the top and the bottom panel units by two ends of the rope unit, or the chamber is contained inside a cloth bag or a net bag, or a means to restrict the axial movement of the compression spring.

In particular, through the action of the valve unit, the fluid flowing in or out of the channel is controlled, and the valve unit is controlled before or during the use of the compression spring to adjust the internal pressure of the fluid inside the chamber, thereby the control of elasticity along the axial direction and deformation is realized.

The advantages of the present invention is as follows:

The present invention provides a compression spring with a corrugated fluid chamber capable of elasticity adjustment, through controlling the action of a valve unit to control the fluid flow in or out of the fluid chamber before or during the use of the compression spring such that the internal pressure of the fluid inside the chamber is controlled, thereby the changes of elasticity along the axial direction is realized. The structure and design is simple, effectively saving cost and resources. The elasticity is easily controlled to fit the application and promotion of use in furniture industries and other industries. The market prospects are great. The compression spring itself does not require any complicated accessories, the main structure has a great diversity and is integrated with the elastic structure and the valve unit, therefore a great variety of design can be achieved to facilitate its changes and logical adjustment for use as an accessory, and the need for different models or makes or the applicability under different principles of compression spring and deformation requirements can be fulfilled.

### BRIEF DESCRIPTION OF THE DRAWINGS

FIG. 1 is a schematic diagram of a compression spring with a corrugated fluid chamber capable of elasticity adjustment according to a preferred embodiment of the present invention.

FIG. 2 is a schematic diagram of a compression spring with a corrugated fluid chamber capable of elasticity adjustment according to another preferred embodiment of the present invention.

Wherein:

1 refers to panel unit, 2 refers to rigid frame structure, 3 refers to channel, 4 refers to valve unit, 5 refers to elastic structure, 6 refers to chamber, and 7 refers to resilient tube body.

### DETAILED DESCRIPTION OF THE PREFERRED EMBODIMENT

### Embodiment

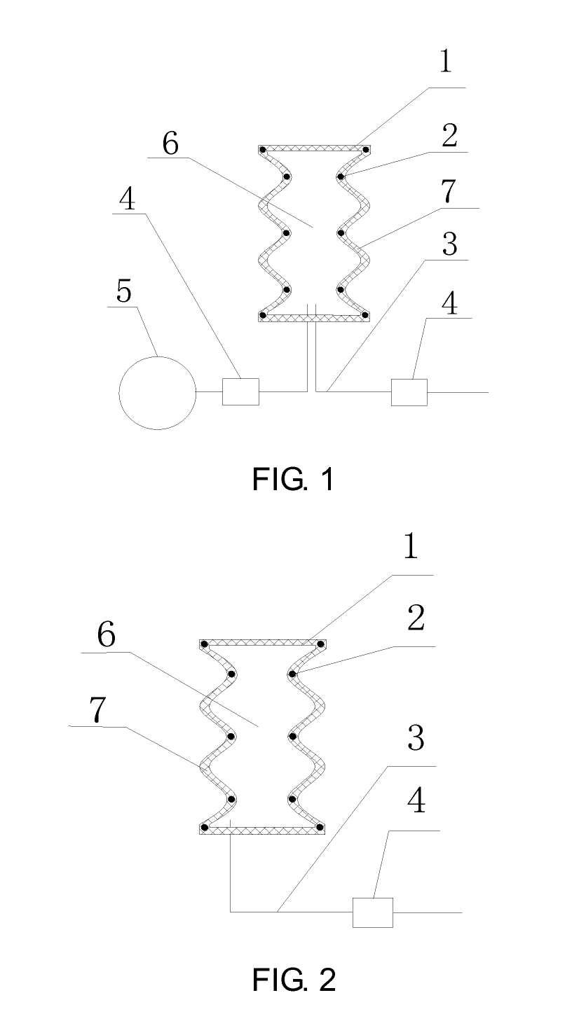

Referring to FIG. 1 to FIG. 2 of the drawings, a compression spring with a corrugated fluid chamber capable of elasticity adjustment includes a main structure which comprises a resilient tube body 7, a top and a bottom panel units 1 enclosing the resilient tube body to form a sealed chamber 6, the chamber 6 connected to one or more elastic structures 5 outside the chamber through a channel 3, a valve unit 4 is provided inside the channel 3 and is capable of holding an excessive fluid, wherein the channel 3 and the chamber 6 are thoroughly connected, wherein the resilient tube body 7 is a corrugated body defining a crest portion, a trough portion and a remaining portion excluding the crest portion and the trough portion, that a rigid frame structure 2 can be mounted on the crest portion and the trough portion such that a wall thickness of the remaining portion is smaller for facilitating an expansion action, wherein when the chamber 6 is filled with a fluid and is pressed along an axial direction of the chamber 6 to change an internal pressure of the fluid inside the chamber 6, the remaining portion is deformed and a volume of the remaining portion is increased to hold a larger amount of fluid or the excessive fluid is forced to flow to the elastic structure 5 outside the chamber, thereby causing a deformation of the chamber 6 along the axial direction; wherein a rope unit can be provided inside the chamber 6 through connecting the top and the bottom panel units by two ends of the rope unit, when the chamber is filled with the fluid, the rope unit limits the compression spring from expanding along the axial direction such that a particular length range for serving a particular use can be fulfilled, wherein the valve unit 4 is controlled before or during the use of the compression spring to allow the fluid to enter into the chamber 6 from outside or to exit the chamber 6 so as to adjust the internal pressure of the fluid inside the chamber 6, thereby the control of elasticity along the axial direction is realized.

The wall thickness of the resilient tube body 7 has a stepped structure in which a thin trough portion is adjacent to a thick crest portion or a thick trough portion is adjacent to a thin crest portion. In the channel 3, a valve unit 4 having a valve opening is provided and the fluid control is controlled by a degree of opening of the valve opening, thereby a damping control of the deformation of the compression spring during operation is achieved. The rigid frame structure 2 is mounted on the crest portion or the trough portion of the chamber 6 and has a ring or any helical spring structure, or no rigid frame structure 2 is provided and a wall thickness of the crest portion and the trough portion of the chamber is increased directly such that any undesirable deformation through compressing the chamber 6 or filling the fluid into the chamber 6 during operation is avoided. The crest portion and the trough portion of the resilient tube body 7 of the chamber 6 is provided with the rigid frame structure 2, an increased wall thickness is employed, or a combination of the rigid frame structure 2 and the increased wall thickness is used. The two ends of the chamber 6 is provided with an increased wall thickness or is mounted with a reinforcement unit of a particular shape for preventing deformation at the two ends. The chamber 6 is provided with a decreased wall thickness such that deformation is caused by the internal pressure to hold fluid, or the chamber 6 is provided with the elastic structure 5 outside the chamber 6 in which the elastic structure 5 is capable of expanding under a particular internal pressure, or a combination of the above two design can be used according to the need.

The corrugated body of the resilient tube body 7 is made in elastic materials, the elastic materials includes rubber, soft plastic, or any synthetic materials. The rope unit is provided inside the chamber 6 through connecting the top and the bottom panel units 1 by two ends of the rope unit, or the chamber 6 is contained inside a cloth bag or a net bag, or any means to restrict the axial movement of the compression spring. Through the action of the valve unit 4, the fluid flow in or out of the channel is controlled, the valve unit 4 is controlled before or during the use of the compression spring to adjust the internal pressure of the fluid inside the chamber 6, thereby the control of elasticity along the axial direction and deformation is realized.

Referring to FIG. 1 and FIG. 2 of the drawings, the basic structural design and principle of the a compression spring with a corrugated fluid chamber capable of elasticity adjustment according to this embodiment is illustrated:

1. According to this embodiment, the basic structural design of the compression spring is as follows: the main structure of the compression spring includes a resilient tube body 7 with two sealed end, and a chamber 6 is formed inside to contain a fluid of gaseous state or liquid state. One or more channel 3 is provided to connect to the chamber 6 and a valve unit 4 is provided in the channel 3. According to the need required, the valve unit 4 can be used to control the fluid flow through the channel 3 into or out from the chamber 6. The major structural material used is elastic materials such as rubber. In the trough portion (minimum diameter), the wall thickness is increased or a rigid frame structure 2 is mounted; or at the crest portion (maximum diameter), the wall thickness is increased or a rigid frame structure 2 is mounted; the rigid frame structure 2 is a ring structure or a helical spring structure. The chamber 6 is constructed with a portion with decreased wall thickness, or an elastic sac unit 5 which is capable of expanding under a certain level of internal pressure is provided for holding the excessive fluid when the internal pressure is increased; inside the chamber 6, a rope unit is provided to connecting the top and the bottom panel units, when the fluid flows inside the chamber 6, the compression spring is restricted to use under a particular length range.

2. According to this embodiment, the technological principle is illustrated as follows: after filling a certain amount of fluid into the chamber 6 of the compression spring with a corrugated fluid chamber capable of elasticity adjustment, a pressure is exerted vertically to the compression spring along the axial direction. The fluid internal pressure inside the chamber 6 is increased such that the portion with a thinner wall in the chamber is deformed and the fluid is forced to this portion to cause an expansion along the radial direction, or the fluid is forced to flow to the elastic sac unit. Both of these two methods can cause the compression spring to be compressed along the axial direction. Under the condition that the axial pressure is the same, the amount of compression along the axial direction is correlated to the fluid pressure preset inside the chamber 6. When the preset fluid pressure is great, the amount of compression along the axial direction is small. Conversely, when the preset fluid pressure is small, the amount of compression along the axial direction is great. Through controlling the action of the valve unit 4 to control the fluid flow in or out of the fluid chamber 6 through the channel 3 before or during the use of the compression spring, the internal fluid pressure inside the chamber 6 can be controlled, thereby the control of elasticity along the axial direction is realized.

Wherein the following measures are employed to ensure that undesirable deformation is prevented and a regular deformation is achieved:

Option 1: a ring frame or a compression frame is mounted at the trough portion;

Option 2: the wall at the trough portion is thicken directly;

Option 3: a ring frame or a compression frame is mounted at the crest portion;

Option 4: the wall at the crest portion is thicken directly;

Option 5: in the top and the bottom panel units at two ends, increase the thickness of the panel units or mount a support plate of any materials which is not easily deformed.

The present invention, while illustrated and described in terms of a preferred embodiment and several alternatives, is not limited to the particular description contained in this specification. Additional alternatives or equivalent components could also be used to practice the present invention.

What is claimed is:

1. A compression spring with a corrugated fluid chamber capable of elasticity adjustment, characterized in that: a main structure comprising a resilient tube body, a top and a bottom panel units enclosing said resilient tube body to form a sealed chamber, said chamber connected to one or more elastic structures outside said chamber through a channel, a valve unit is provided inside said channel and is capable of holding an excessive fluid, wherein said channel and said chamber are thoroughly connected, wherein said resilient tube body is a corrugated body defining a crest portion, a trough portion and a remaining portion excluding said crest portion and said trough portion, and a rigid frame structure can be mounted on said crest portion and said trough portion such that a wall thickness of said remaining portion is smaller for facilitating an expansion action, wherein when said chamber is filled with a fluid and is pressed along an axial direction of said chamber to change an internal pressure of the fluid inside said chamber, said remaining portion of said resilient tube body is deformed and a volume of said remaining portion is increased to hold a larger amount of fluid or the excessive fluid is forced to flow through said channel to said elastic structure outside said chamber, thereby causing a deformation of said chamber along the axial direction; wherein a rope unit can be provided inside the chamber through connecting said top and said bottom panel units by two ends of said rope unit, when said chamber is filled with the fluid, said rope limits the compression spring from expanding along the axial direction to define a particular length range for use to serve as a particular use, said valve unit is controlled before or during the use of said compression spring to allow the fluid to enter into said chamber from outside or to exit said chamber so as to adjust the internal pressure of the fluid inside said chamber, thereby the control of elasticity along the axial direction is realized.

2. The compression spring with a corrugated fluid chamber capable of elasticity adjustment according to claim 1, characterized in that, the wall thickness of said resilient tube body has a stepped structure in which the wall thickness of said crest portion is greater than the wall thickness of said trough portion at which said crest portion is adjacent to, or the wall thickness of said crest portion is smaller than the wall thickness of said trough portion at which said crest portion is adjacent to.

3. The compression spring with a corrugated fluid chamber capable of elasticity adjustment according to claim 1, characterized in that, said valve unit inside said channel has a valve opening and the fluid control is controlled by a degree of opening of said valve opening, thereby a damping control of the deformation of said compression spring during operation is achieved.

4. The compression spring with a corrugated fluid chamber capable of elasticity adjustment according to claim 1, characterized in that, said rigid frame structure is mounted on said crest portion or said trough portion of said resilient tube body and has a ring or helical structure, or a wall thickness or said crest portion and said trough portion of said resilient tube body is increased such that any desirable deformation through compressing said chamber or filling the fluid into said chamber during operation is avoided instead of providing said rigid frame structure to said crest portion or said trough portion of said resilient tube body.

5. The compression spring with a corrugated fluid chamber capable of elasticity adjustment according to claim 1 or 4, characterized in that, said crest portion and said trough portion of said resilient tube body is provided with said rigid frame structure, an increased wall thickness, or a combination of said rigid frame structure and increased wall thickness.

6. The compression spring with a corrugated fluid chamber capable of elasticity adjustment according to claim 1, characterized in that, said two ends of said chamber is provided with an increased wall thickness or with an reinforcement unit of a particular shape for preventing deformation at said two ends.

7. The compression spring with a corrugated fluid chamber capable of elasticity adjustment according to claim 1, characterized in that, said chamber is provided with a decreased wall thickness such that an increased volume is caused through deformation by the internal pressure, or said chamber is provided with said elastic structure outside said chamber in which said elastic structure is capable of expanding under a particular internal pressure, or said chamber is provided with a decreased wall thickness such that an increased volume is caused through deformation by the internal pressure as well as said elastic structure outside said chamber in which said elastic structure is capable of expanding under a particular internal pressure.

8. The compression spring with a corrugated fluid chamber capable of elasticity adjustment according to claim 1, characterized in that, said corrugated body of said resilient tube body is made in elastic materials, said elastic materials includes rubber, soft plastic, or any synthetic materials.

9. The compression spring with a corrugated fluid chamber capable of elasticity adjustment according to claim 1, characterized in that: said rope unit is provided inside the chamber through connecting said top and said bottom panel units by two ends of said rope unit, or said chamber is contained inside a cloth bag or a net bag, or a means to restrict the axial movement of said compression spring.

10. The compression spring with a corrugated fluid chamber capable of elasticity adjustment according to claim 1, characterized in that: through the action of said valve unit, the fluid flow in or out of said channel is controlled, said valve unit is controlled before or during the use of said compression spring to adjust the internal pressure of the fluid inside said chamber, thereby the control of elasticity along the axial direction and deformation is realized.
